(19) United States
(12) Patent Application Publication
(10) Pub. No.: US 2017/0071369 A1
(43) Pub. Date: Mar. 16, 2017

(54) ELECTRONIC PILLOW PAD OF SNORE AND NOISE CANCELLATION AND THE METHOD THEREOF

(71) Applicant: Chung Yuan Christian University, Taoyuan City (TW)

(72) Inventors: Cheng-Yuan CHANG, Taoyuan City (TW); Sen-Maw KUO, Wildwood, MO (US)

(21) Appl. No.: 14/954,404

(22) Filed: Nov. 30, 2015

(30) Foreign Application Priority Data
Sep. 10, 2015 (TW) 104129896

(51) Int. Cl. A47G 9/10; G10K 11/178

(52) U.S. Cl. CPC A47G 9/10; G10K 11/1786; A47G 2009/006

(57) ABSTRACT

An electronic pillow pad of snore and noise cancellation includes: a pillow pad having a plurality of microphones, a plurality of speakers, and a first communication unit, and a mobile device having a second communication unit and a control unit. When the first communication unit of the pillow pad is connected with the second communication unit of the mobile device, the control unit of the mobile device generates a plurality of control signals in the light of the audio signal or the noise signal detected by the microphones of the pillow pad, and the speakers of the pillow pad are controlled by the mobile device with the control signals to output the audio signal or the anti-noise signal that cancels out the noise signal.

### FIELD OF THE INVENTION

The present invention relates to an electronic pillow pad, particularly relates to an electronic pillow pad of snore and noise cancellation and cancellation method thereof.

### BACKGROUND OF THE INVENTION

Day-and-night arrhythmia may cause sleep disorder, besides, sudden and persistent noise also influences sleep quality, too. Noise such as transformer at home or neighboring snore may cause not only slight influences such as poor sleep quality, sleep interruption or early wake-up, but also severe diseases such as depression disorder, anxiety disorder or sleep apnea, which truly causes impacts on human health. Taking sleep pills for good sleep quality can cause risks of suffering from mental illness such as dementia. Thus, noise cancellation is a true approach for overcoming poor sleep quality.

Presently, methods of noise cancellation are classified into passive noise control (PNC) and active noise control (ANC). Passive noise control is sound reduction by noise-isolating material such as sound-absorbing cotton. However, passive noise control neither truly eliminates noise nor totally overcomes low-frequency noise even using thick and weighty sound-absorbing cotton. Moreover, it is difficult in practice for a sleeping bed to use thick and weighty sound-absorbing cotton to surround it for noise cancellation. Clinically, patient suffering from snore is treated by intrusive methods, such as surgery or wearing tooth crown to lighten snore symptom. But those intrusive methods make patient feel uncomfortable, so they are not general. Active noise control is a method for reducing unwanted sound by the addition of anti-noise signal. The anti-noise signal, whose phase is opposite to noise but amplitude is same as the ones of noise, is generated by a speaker according to a result of environment noise detection by a microphone. The environment noise cancellation can be achieved with the anti-noise signal to destroy strength of noise signal by forming destructive interference. Present active noise control is generally mounted onto a bed headboard, detects snore signal with a microphone to be calculated by a digital signal processor, and outputs anti-noise signal with a speaker on the bed headboard for purpose of snore cancellation. Such anti-noise signal is of 100˜300 Hz frequency and 5˜10 dB. However, such the bed headboard is of heavy volume not to be easily moved and portable. Moreover, the range of snore cancellation is restricted within the surrounding of the microphone and of limited result unless the microphone is hung near sleeping human's ear.

Besides, U.S. Pat. No. 8,325,934 discloses an electronic pillow to use a digital signal processor as a platform of signal calculation/processing and combine analog to digital converter (ADC), digital to analog converter (DAC), and input and output (I/O) peripheral circuit for implement of electronic pillow. Compared to traditional bed headboard noise cancellation equipment, though the electronic pillow improves portability, however, it still has an unfriendly volume for a traveler and high cost because of equipment of the digital signal processor. Consequently, such an electronic pillow neither has low price nor provides portable convenience.

Accordingly, the present invention provides an electronic pillow pad, and especially, an electronic pillow pad and cancellation method to integrate active noise control, adaptive acoustic echo cancellation, music listening, and sleeping monitor and record for noise and snore cancellation.

### SUMMARY OF THE INVENTION

One of objectives of the present invention provides an electronic pillow pad by using a mobile device as the platform of signal calculation/processing to replace the digital signal processor in a traditional active noise control. The mobile device is configured to execute feedback active noise control and generate control signals for controlling a speaker to output anti-noise that can cancel out the noise detected by a microphone. The cancellation of snore and noise, reduction of product cost and weight, readily portable convenience, and improvement of sleep quality can be achieved.

One of objectives of the present invention provides an electronic pillow pad of audio function that integrates a mobile device to execute a dual-channel and audio-integrating active noise control program and utilize a speaker to output audio signal of music and anti-noise. Thus, snore and noise can be abated or cancelled, and audio signal of music can be preserved. Consequently, the electronic pillow pad can replace stereo on headboard and help user quickly fall asleep by output relaxing music.

One of objectives of the present invention provides an electronic pillow pad of hands-free communication function for convenience of patient lying in bed to receive a call. A mobile device executes an adaptive acoustic echo cancellation program and outputs sound and anti-noise with a speaker to cancel echo interference in communication and ensure answering important calls.

One of objectives of the present invention provides an electronic pillow pad of sleep monitor and record function. A microphone is utilized to detect the snore of a sleepy user. The snore information may be transferred to a mobile device, stored in a memory, or analyzed via cloud computing. Consequently, user's snoring condition can be understood and further utilized to improve sleep quality.

Accordingly, an electronic pillow pad of snore and noise cancellation includes: a pillow pad having a plurality of microphones, a plurality of speakers, and a first communication unit, wherein the microphones are respectively electrically coupled to the first communication unit and configured to at least detect an audio signal or a noise signal, and the speakers are respectively electrically coupled to the first communication unit and configured to at least output the audio signal or an anti-noise signal; and a mobile device having a second communication unit and a control unit, wherein the control unit is electrically coupled to the second communication unit; and wherein when the first communication unit of the pillow pad is connected with the second communication unit of the mobile device, the control unit of the mobile device generates a plurality of control signals in the light of the audio signal or the noise signal detected by the microphones of the pillow pad, and the speakers of the pillow pad are controlled by the mobile device with the control signals to output the audio signal or the anti-noise signal that cancels out the noise signal. Thus, snore and noise cancellation and sleep quality improvement are achieved.

Accordingly, a method of snore and noise cancellation includes: starting a pillow pad and a control unit in a mobile device; coupling a first communication unit in the pillow pad with a second communication unit in the mobile device; at least detecting an audio signal or a noise signal by a plurality of microphones in the pillow pad; generating a plurality of control signals by the control unit in the mobile device according to the audio signal or the noise signal detected by the microphones; and at least outputting the audio signal or an anti-noise signal by a plurality of speakers that are controlled by the mobile device with the control signals.

### BRIEF DESCRIPTION OF THE DRAWINGS

FIG. 1 is a schematic system block diagram illustrating an electronic pillow pad of snore and noise cancellation according to the present invention.

FIG. 2 is a schematic diagram illustrating the structure of an electronic pillow pad according to the present invention.

FIG. 3 is a schematic diagram illustrating signal of microphones for an electronic pillow pad according to the present invention.

FIG. 4 is a schematic flow diagram illustrating one embodiment signal of feedback active noise control according to the present invention.

FIG. 5 is a schematic flow diagram illustrating another embodiment signal of dual-channel active noise control program integrated with audio signal according to the present invention.

FIG. 6 is a schematic flow diagram illustrating one embodiment signal of adaptive acoustic echo cancellation program according to the present invention.

FIG. 7 is a schematic flow diagram illustrating a method of snore and noise cancellation according to the present invention.

### DETAILED DESCRIPTION OF THE PREFERRED EMBODIMENT

The above objects, technical features and advantages of the present invention will become more readily apparent to those ordinarily skilled in the art after reviewing the following detailed description and accompanying drawings. The presently described embodiments will be understood by reference to the drawings, but the sizes or ratios of components shown in drawings are not intended to limit the scope of the disclosure.

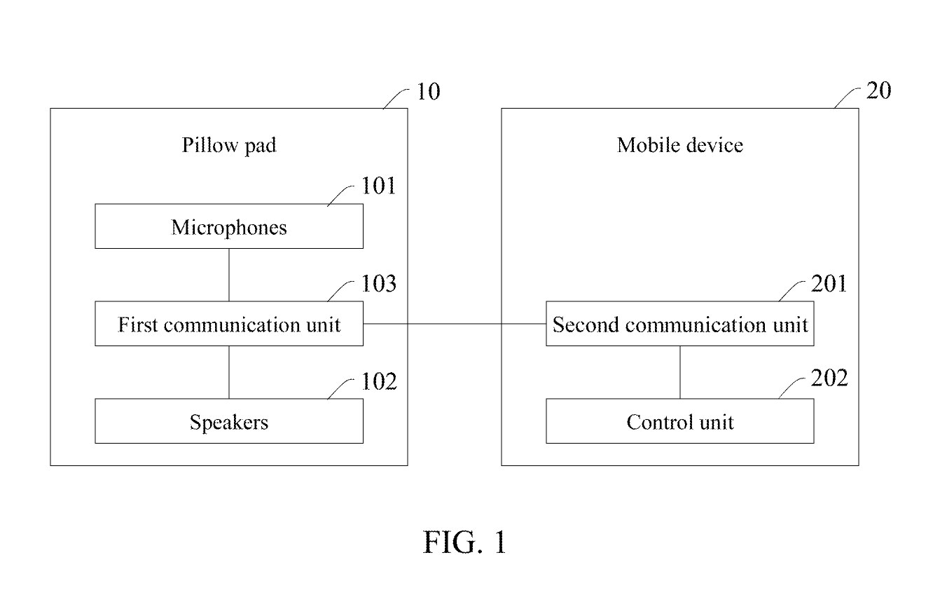

FIG. 1 is a schematic system block diagram illustrating an electronic pillow pad of snore and noise cancellation according to the present invention. Shown in FIG. 1, an electronic pillow pad of snore and noise cancellation includes a pillow pad 10 having some microphones 101, some speakers 102, and a first communication unit 103, and a mobile device 20 having a second communication unit 201, and a control unit 202. These microphones 101 are electrically coupled to the first communication unit 103 and configured to at least detect audio signal to be wanted (such as music) or noise signal not to be wanted (such as snore or low frequency noise from electric equipments). The speakers 102 are electrically coupled to the first communication unit 103 and configured to at least output audio signal or anti-noise signal. The control unit 202 is electrically coupled to the second communication unit 201. After the second communication unit 201 of the mobile device 20 is coupled to the first communication unit 103 of the pillow pad 10, the control unit 202 generates multitudes of control signals in the light of at least the audio signal or noise signal detected by the microphones 101. The speakers 102 are controlled by the control signals of the mobile device 20 to at least output the audio signal or anti-noise signal that cancels out the noise signal. Thus, snore and noise can be cancelled and sleep quality can be improved.

In a preferred embodiment of electronic pillow pad, the pillow pad 10 further includes a power supply device of alternative current power or battery power to provide power to the microphones 101, the speakers 102, and the first communication unit 103.

In a preferred embodiment of electronic pillow pad, the mobile device 20 further includes a memory to record and store information.

In a preferred embodiment of electronic pillow pad, the mobile device 20 may be a smart phone, a tablet computer or a mobile telecommunication, but not limited to.

In a preferred embodiment of electronic pillow pad, the first communication unit 103 and the second communication unit 201 may be one of a wired telecommunication module and a wireless telecommunication module.

In a preferred embodiment of electronic pillow pad, the wireless telecommunication module may be a blue tooth module.

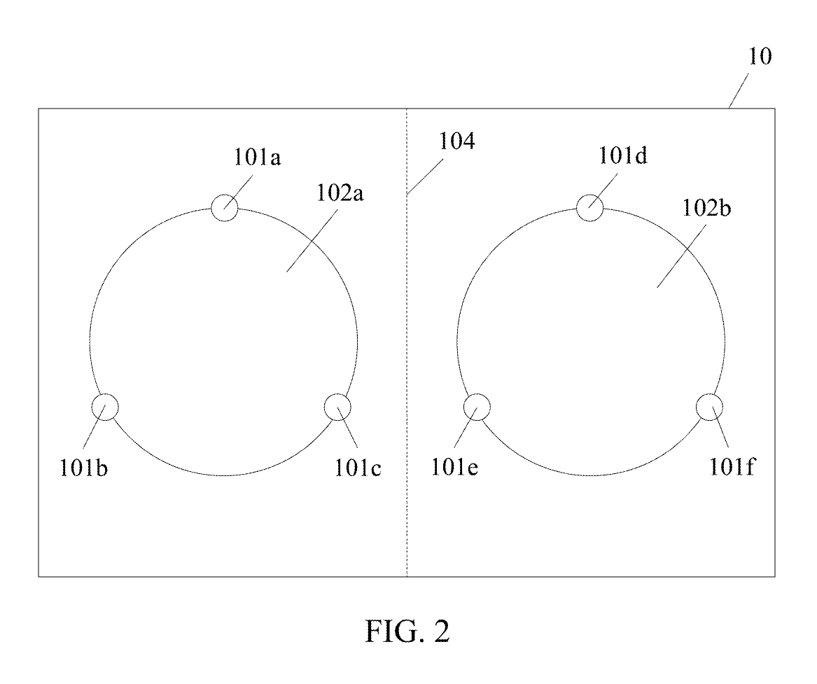

FIG. 2 is a schematic diagram illustrating the structure of an electronic pillow pad according to the present invention. Shown in FIG. 2, the pillow pad 10 includes six microphones 101a, 101b, 101c, 101d, 101e, and 101f, and two speakers 102a and 102b. The speakers 102a and 102b are electrically coupled to the first communication unit 103 (not shown in FIG. 2), respectively deposited at two sides of a folding line 104 of the pillow pad 10 to close to the position corresponding to user's ear, and configured to at least output the audio signal or anti-noise signal. The six microphones 101a, 101b, 101c, 101d, 101e, and 101f are electrically coupled to the first communication unit 103. The three microphones 101a, 101b, and 101c are deposited in the pillow pad 10 and equally surrounded around the speaker 102a. The three microphones 101d, 101e, and 101f are deposited in the pillow pad 10 and equally surrounded around the speaker 102b. The six microphones 101a, 101b, 101c, 101d, 101e, and 101f at least detect the audio signal or the noise signal at six different positions. The pillow pad 10 may be deposited on a pillow, a sofa, or other thing capable of being leaned. When the user's head leans on the pillow pad 10, the pillow pad 10 may create two quiet zones at the sides of the user's ears to cancel snore and noise. It is noted that the numbers and arrangement of the microphones 101a, 101b, 101c, 101d, 101e, and 101f and the speakers 102a and 102b in the pillow pad 10 are only one embodiment for function and effect illustration of the pillow pad 10, not to be limited in the present invention or limit the scope of the present invention.

Besides, in a preferred embodiment of electronic pillow pad, the pillow pad 10 may be made of soft material. Shown in FIG. 2, user may fold it along with the folding line 104 to reduce the size of the pillow pad 10 for portable convenience.

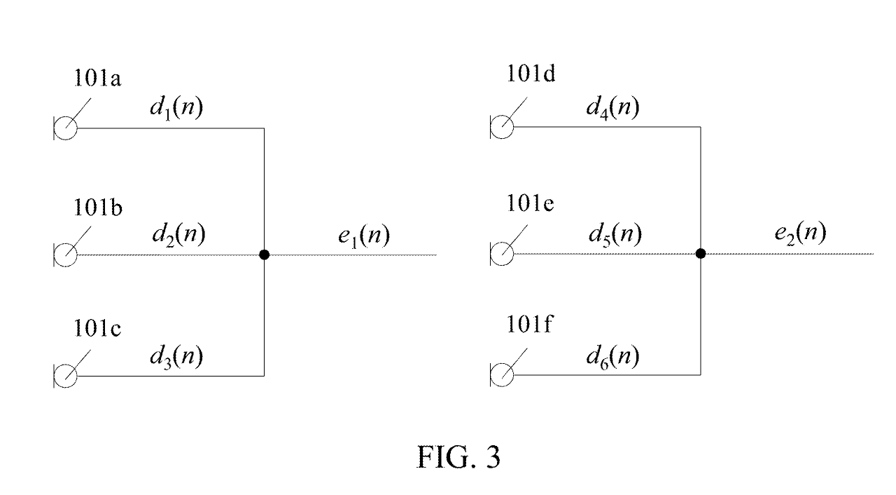

FIG. 3 is a schematic diagram illustrating signal of microphones for an electronic pillow pad according to the present invention. Please refer to FIG. 2 and FIG. 3, the positive terminals of the three microphones 101a, 101b, and 101c are coupled with each another, as well as the negative terminals of the three microphones 101a, 101b, and 101c. The three microphones 101a, 101b, and 101c respectively detect signals d₁(n), d₂(n), and d₃(n) at different positions and combine them to new signal e₁(n). Similarly, the positive terminals of the three microphones 101d, 101e, and 101f are coupled with each another, as well as the negative terminals of the three microphones 101d, 101e, and 101f. The three microphones 101d, 101e, and 101f respectively detect signals d₄(n), d₅(n), and d₆(n) at different positions and combine them to new signal e₂(n). The signals d₁(n), d₂(n), d₃(n), d₄(n), d₅(n), and d₆(n) may be noise signals, audio signals or the combination thereof.

In electronic pillow pad of the present invention, the mobile device 20 further includes a feedback active noise control program, a dual-channel audio-integrating active noise control program, and an adaptive acoustic echo cancellation program. A mobile phone application program is preferred ones for these programs aforementioned. Once user starts the mobile phone application program of the mobile device 20, the second communication unit 201 in the mobile device 20 and the first communication unit 103 in the pillow pad 10 link with each other, and the control unit 202 in the mobile device 20 executes the functions of the mobile phone application program.

The operation of the programs will be described as follows.

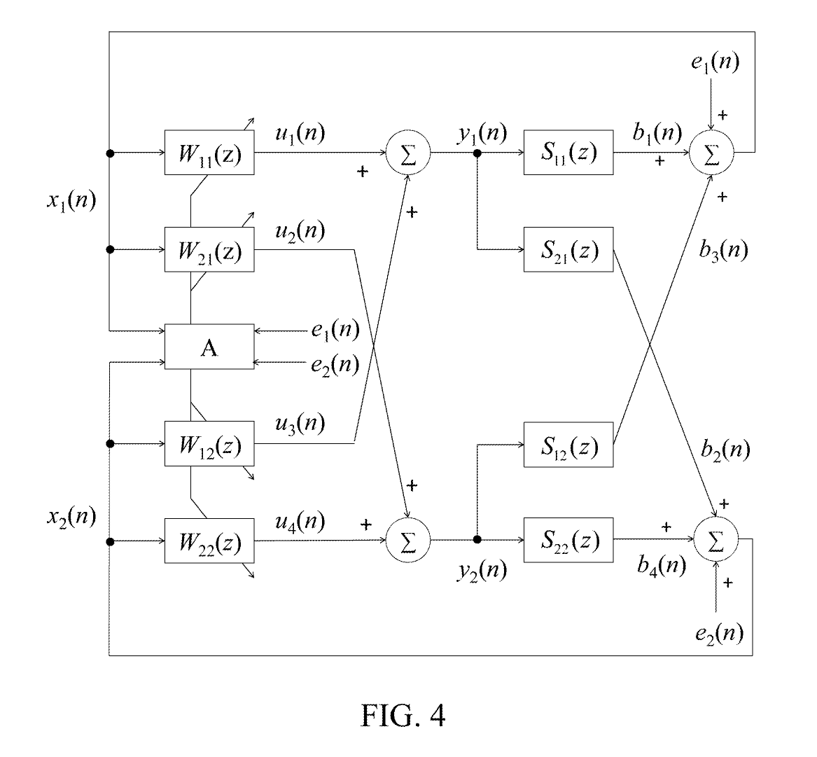

FIG. 4 is a schematic flow diagram illustrating one embodiment signal of feedback active noise control according to the present invention. Please refer to FIG. 2 to FIG. 4, the feedback active noise control program utilizes the six microphones 101a, 101b, 101c, 101d, 101e, and 101f and the two speakers 102a and 102b deposited in the pillow pad 10 as signal input or output device. It is noted that S₁₁(z) in FIG. 4 is a frequency response of secondary path from the three microphones 101a, 101b, and 101c to the speaker 102a, S₂₁(z) is the one from the three microphones 101a, 101b, and 101c to the speaker 102b, S₂₂(z) is the one from the three microphones 101d, 101e, and 101f to the speaker 102b, and S₁₂(z) is the one from the three microphones 101d, 101e, and 101f to the speaker 102a. Four estimated frequency responses of secondary path Ŝ₁₁(z), Ŝ₂₁(z), Ŝ₂₂(z) and Ŝ₁₂(z) are respectively corresponding to the frequency response of secondary paths S₁₁(z), S₂₁(z), S₂₂(z), and S₁₂(z) and applied to filtering algorithm A. The estimated frequency responses of secondary path Ŝ₁₁(z), Ŝ₂₁(z), Ŝ₂₂(z), and Ŝ₁₂(z) are determined by selecting a little suitable testing signal (such as white noise) to be outputted by the two speakers 102a and 102b and detected by the six microphones 101a, 101b, 101c, 101d, 101e, and 101f. Once the first communication unit 103 in the pillow pad 10 and the second communication unit 201 in the mobile device 20 are connected, the pillow pad 10 and the mobile device 20 begin to receive and transmit signal. The three microphones 101a, 101b, and 101c respectively detect the noise signals and then combine them to generate new signal e₁(n) according to the one shown in FIG. 3. Meanwhile, the other three microphones 101d, 101e, and 101f also respectively detect the noise signals and then combine them to generate another new signal e₂(n) according to the one shown in FIG. 3. Once the control unit 202 in the mobile device 20 receives the two signals e₁(n) and e₂(n), the feedback active noise control program of this embodiment starts to be executed. Firstly, both the two signals e₁(n) and e₂(n) and the two signals x₁(n) and x₂(n) may be inputted into the filtering algorithm A, the filtering algorithm A will adjust four adaptive filters W₁₁(z), W₂₁(z), W₁₂(z), and W₂₂(z) in the form of equations. After receiving the signal x₁(n), the adjusted adaptive filters W₁₁(z) and W₂₁(z) respectively generate two control signals u₁(n) and u₂(n). At same time, after receiving the signal x₂(n), the adjusted adaptive filters W₁₂(z) and W₂₂(z) respectively generate two control signals u₃(n) and u₄(n), too. Next, anti-noise signal y₁(n) may be generated after the two control signals u₁(n) and u₃(n) are processed. Another anti-noise signal y₂(n) may be generated after the two control signals u₂(n) and u₄(n) are processed, too. The two anti-noise signals y₁(n) and y₂(n) may be transferred into the pillow pad 10 by the mobile device 20 and respectively outputted by the two speakers 102a and 102b. Moreover, the anti-noise signal y₁(n) is transferred into the frequency responses of secondary path S₁₁(z) and S₂₁(z) that respectively then output signals b₁(n) and b₂(n). At same time, another anti-noise signal y₂(n) is transferred into the frequency responses of secondary path S₂₂(z) and S₂₁(z) that respectively then output signals b₃(n) and b₄(n). Next, a next signal x₁(n) may be generated after the two signals b₁(n) and b₃(n) together with next signal e₁(n) are processed. Similarly, a next signal x₂(n) may be generated after the two signals b₂(n) and b₄(n) together with next signal e₂(n) are processed. The next signals x₁(n), x₂(n) and the next signals e₁(n), e₂(n) can be continuously inputted into the filtering algorithm A and the four adaptive filters W₁₁(z), W₂₁(z), W₁₂(z), and W₂₂(z) for execution of processes aforementioned. In the embodiment, the filtering algorithm A may be Filtered-X Least Mean Square algorithm, but not limited to. The feedback active noise control program of the embodiment is implemented by the control unit 202 in the mobile device 20 and generates the control signals u₁(n), u₂(n), u₃(n), and u₄(n) in the light of the noise signals detected by the microphones 101a, 101b, 101c, 101d, 101e, and 101f. The speakers 102a and 102b in the pillow pad 10 are controlled by the mobile device 20 with the control signals u₁(n), u₂(n), u₃(n), and u₃(n), and output the anti-noise signals y₁(n) and y₂(n) for the snore and noise cancellation.

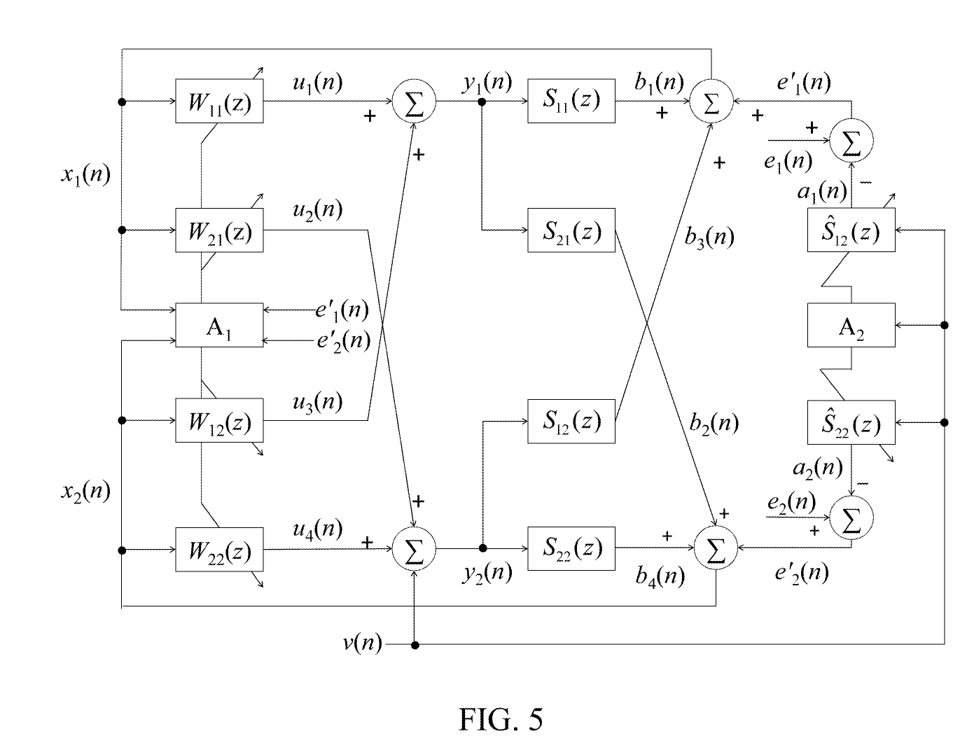

FIG. 5 is a schematic flow diagram illustrating another embodiment signal of dual-channel and audio-integrating active noise control program according to the present invention. Please refer to FIG. 2, FIG. 3 and FIG. 5, the embodiment signal of dual-channel and audio-integrating active noise control program utilizes the six microphones 101a, 101b, 101c, 101d, 101e, and 101f and two speakers 102a and 102b that are near the ear and in the pillow pad 10 as signal input or output devices. It is noted that S₁₁(z) in FIG. 5 is a frequency response of secondary path from the three microphones 101a, 101b, and 101c to the speaker 102a, S₂₁(z) is the one from the three microphones 101a, 101b, and 101c to the speaker 102b, S₂₂(z) is the one from the three microphones 101d, 101e, and 101f to the speaker 102b, and S₁₂(z) is the one from the three microphones 101d, 101e, and 101f to the speaker 102a. Four corresponding estimated frequency responses of secondary path Ŝ₁₁(z), Ŝ₂₁(z), Ŝ₂₂(z), and Ŝ₁₂(z) are determined by selecting a little suitable testing signal (such as white noise) to be outputted by the two speakers 102a and 102b and detected by the six microphones 101a, 101b, 101c, 101d, 101e, and 101f, and the four estimated frequency responses of secondary path may be applied into the filtering algorithm A₁ for the adjustment of four adaptive filters W₁₁(z), W₂₁(z), W₁₂(z), and W₂₂(z). Once the first communication unit 103 in the pillow pad 10 and the second communication unit 201 in the mobile device 20 are connected with each other, the pillow pad 10 and the mobile device 20 start to receive and transmit signal. The three microphones 101a, 101b, and 101c respectively detect the noise signals and audio signal of music at different positions and then combine them to generate new signal e₁(n) according to the one shown in FIG. 3. Meanwhile, the other three microphones 101d, 101e, and 101f also respectively detect the noise signals and audio signal of music at different positions and then combine them to generate another new signal e₂(n) according to the one shown in FIG. 3, too. Once the control unit 202 in the mobile device 20 receives the two signals e₁(n) and e₂(n), the dual-channel and audio-integrating active noise control program of this embodiment starts to be executed. Firstly, the audio signal of music v(n) may be inputted into the filtering algorithm A₂, the filtering algorithm A₂ will adjust two estimated frequency responses of secondary path Ŝ₁₂(z) and Ŝ₂₂(z). After receiving the audio signal of music v(n), the two estimated frequency responses of secondary path Ŝ₁₂(z) and Ŝ₂₂(z) respectively generate two signals a₁(n) and a₂(n). Next, signal e′₁(n) may be generated after the two signals a₁(n) and e₁(n) are processed. Another signal e′₂(n) may be generated after the two signals a₂(n) and e₂(n) are processed, too. Next, both the two signals e′₁(n) and e′₂(n) and the two signals x₁(n) and x₂(n) may be inputted into the filtering algorithm A₁, the filtering algorithm A₁ will adjust four adaptive filters W₁₁(z), W₂₁(z), W₁₂(z), and W₂₂(z) in the form of equations. After receiving the signal x₁(n), the adjusted adaptive filters W₁₁(z) and W₂₁(z) respectively generate two control signals u₁(n) and u₂(n). At same time, after receiving the signal x₂(n), the adjusted adaptive filters and W₁₂(z) and W₂₂(z) respectively generate two control signals u₃(n) and u₄(n), too. Next, anti-noise signal y₁(n) may be generated after the two control signals u₁(n) and u₃(n) are processed. Another anti-noise signal y₂(n) that includes the audio signal of music v(n) may be generated after the two control signals u₂(n) and u₄(n) and the audio signal of music v(n) are processed. The two anti-noise signals y₁(n) and y₂(n) may be transferred into the pillow pad 10 by the mobile device 20 and respectively outputted by the two speakers 102a and 102b. Moreover, the anti-noise signal y₁(n) can pass through the frequency responses of secondary path S₁₁(z) and S₂₁(z), and then the signals b₁(n) and b₂(n) are outputted. At same time, another anti-noise signal y₂(n) also passes through the frequency responses of secondary path S₁₂(z) and S₂₂(z), and then the signals b₃(n) and b₄(n) are outputted. Next, a next signal x₁(n) may be generated after the two signals b₁(n) and b₃(n) together with next signal e′₁(n) are processed. Similarly, a next signal x₂(n) will be generated after the two signals b₂(n) and b₄(n) together with next signal e′₂(n) are processed. The next signals x₁(n) and x₂(n) and the next signals e′₁(n) and e′₂(n) can be continuously inputted into the filtering algorithm A₁ and the four adaptive filters W₁₁(z), W₂₁(z), W₁₂(z), and W₂₂(z) for execution of processes aforementioned. In the embodiment, the filtering algorithm Aₗ may be Filtered-X Least Mean Square algorithm, and filtering algorithm A₂ may be Least Mean Square algorithm, but not limited to. The dual-channel and audio-integrating active noise control program of the embodiment is implemented by the control unit 202 in the mobile device 20 and generates the control signals u₁(n), u₂(n), u₃(n), and u₄(n) in the light of the noise signals and audio signals v(n) detected by the microphones 101a, 101b, 101c, 101d, 101e, and 101f. The speakers 102a and 102b in the pillow pad 10 are controlled by the mobile device 20 with the control signals u₁(n), u₂(n), u₃(n), and u₄(n), and output the anti-noise signals y₁(n) and y₂(n) and the audio signal of music v(n) for the snore and noise cancellation and retaining the audio signal of music v(n).

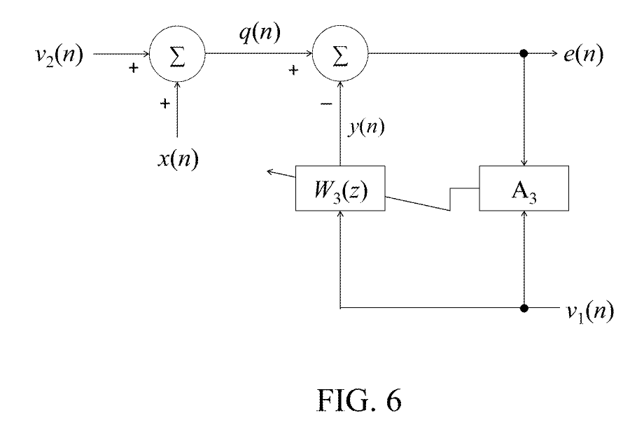

FIG. 6 is a schematic flow diagram illustrating one embodiment signal of adaptive acoustic echo cancellation program according to the present invention. Please refer to FIG. 2 and FIG. 6, one microphone 101a near one side of ear and the speaker 102a at the side same as the microphone 101a in the pillow pad 10 are utilized for the exemplary adaptive acoustic echo cancellation program, but not limited to. Audio signal v₁(n) of an answer is outputted by the speaker 102a, influenced by acoustic media and converted into the noise signal x(n) in echo form, detected by the microphone 101a, and then transferred back to the answer's ear. The noise signal x(n) and user's audio signal v₂(n) can be combined into a signal q(n) and detected by the microphone 101a. The voice signal v₁(n) is inputted into the adaptive filter W₃(z) in the form of equation, and then the adaptive filter W₃(z) can generate signal y(n). Next, the audio signal e(n) without echo interference is generated after signals q(n) and y(n) are processed, and then transferred into the answer's ear. The audio signal e(n) and the answer's audio signal v₁(n) are inputted into a filtering algorithm A₃ for processing and utilized to adjust the adaptive filter W₃(z) in the form of equation. In the embodiment, the filtering algorithm A₃ may be a Least Mean Square algorithm, but not limited to. The adaptive acoustic echo cancellation program of the embodiment is implemented by the control unit 202 in the mobile device 20 and generates the control signals in the light of the audio signal v₂(n) and the noise signal x(n) detected by the microphone 101a in the pillow pad 10 and the audio signal v₁(n) of a remote answer outputted by the speaker 102a. The speaker 102a in the pillow pad 10 is controlled by the mobile device 20 with the control signal and outputs the audio signal v₁(n) the anti-noise signal y(n) for cancellation of the noise signal x(n) resulting from echo in communication.

Accordingly, the electronic pillow pad of the present invention includes the control unit 202 to have functions as follows: (1) the active noise control program used to cancel snore and noise; (2) the dual-channel and audio-integrating active noise control program used to cancel snore and noise but retain audio signal such as music; and (3) adaptive acoustic echo cancellation program used to cancel echo resulted from telecommunication.

Next, the electronic pillow pad of the present invention includes the control unit 202 to have sleeping monitor and record functions. When the microphone 101 in the pillow pad 10 detects the user's snore, it may transfer the audio signal of snore to the memory of the mobile device 20 for snore audio signal estimation by doctor.

The method of snore and noise cancellation is illustrated as follows.

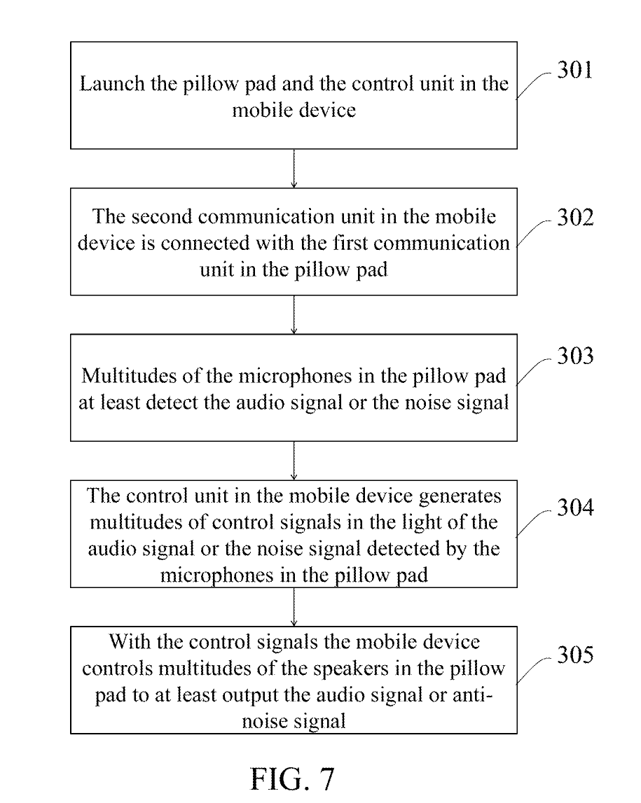

FIG. 7 is a schematic flow diagram illustrating a method of snore and noise cancellation according to the present invention. Shown in FIG. 7, step 301: user launches the pillow pad 10 and the control unit 202 in the mobile device 20, and the second communication unit 201 in the mobile device 20 may be automatically launched by the control unit 202; step 302: the second communication unit 201 in the mobile device 20 is connected with the first communication unit 103 in the pillow pad 10; step 303: multitudes of the microphones 101 in the pillow pad 10 at least detect the audio signal or the noise signal; step 304: the control unit 202 in the mobile device 20 generates multitudes of control signals in the light of the audio signal or the noise signal detected by the microphones 101 in the pillow pad 10; and step 305: with the control signals the mobile device 20 controls multitudes of the speakers 102 in the pillow pad 10 to at least output the audio signal or anti-noise signal.

Accordingly, an electronic pillow pad of snore and noise cancellation is provided, which includes: the pillow pad 10 having multitudes of the microphones 101, multitudes of the speakers 102 and the first communication unit 103; and the mobile device 20 having the second communication unit 201 and the control unit 202. When the first communication unit 103 of the pillow pad 10 and the second communication unit 201 of the mobile device 20 are connected, the control unit 202 generates multitudes of control signals in the light of the audio signal or noise signal detected by the microphones 101, and the mobile device 20 controls the speakers 102 with the control signal to at least output the audio signal or anti-noise signal that may cancel out the noise signal. With the electronic pillow pad, a method of integrating active noise control, hand-free communication, music listening, and sleeping monitor and record is also provided for the purposes of snore and noise cancellation and improvement on sleep quality.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. An electronic pillow pad of snore and noise cancellation, comprising:
a pillow pad having a plurality of microphones, a plurality of speakers, and a first communication unit, wherein the microphones are respectively electrically coupled to the first communication unit and configured to at least detect an audio signal or a noise signal, and the speakers are respectively electrically coupled to the first communication unit and configured to at least output the audio signal or an anti-noise signal; and
a mobile device having a second communication unit and a control unit, wherein the control unit is electrically coupled to the second communication unit; and
wherein when the first communication unit of the pillow pad is connected with the second communication unit of the mobile device, the control unit of the mobile device generates a plurality of control signals in light of the audio signal or the noise signal detected by the microphones of the pillow pad, and the speakers of the pillow pad are controlled by the mobile device with the control signals to output the audio signal or the anti-noise signal that cancels out the noise signal.

2. The electronic pillow pad of snore and noise cancellation of claim 1, wherein the mobile device further comprises a memory.

3. The electronic pillow pad of snore and noise cancellation of claim 2, wherein the pillow pad is made of soft material and foldable along with a folding line to compact volume.

4. The electronic pillow pad of snore and noise cancellation of claim 1, wherein the mobile device is a smart phone or a tablet computer.

5. The electronic pillow pad of snore and noise cancellation of claim 1, wherein the first communication unit and the second communication unit are one of a wired communication module and a wireless communication module.

6. The electronic pillow pad of snore and noise cancellation of claim 5, wherein the wireless communication module is a Bluetooth module.

7. The electronic pillow pad of snore and noise cancellation of claim 1, wherein the control unit executes a feedback active noise control program and the feedback active noise control program generates the control signals in light of the noise signals detected by the microphones of the pillow pad, and the speakers are controlled by the mobile device with the control signals to output the anti-noise signal that cancels the noise signal.

8. The electronic pillow pad of snore and noise cancellation of claim 1, wherein the control unit executes a dual-channel and audio-integrating active noise control program and the dual-channel and audio-integrating active noise control program generates the control signals in light of the audio signal and the noise signal detected by the microphones of the pillow pad, and the speakers of the pillow pad are controlled by the mobile device with the control signals to output the audio signal and the anti-noise signal that cancels out the noise signal, and retains the audio signal.

9. The electronic pillow pad of snore and noise cancellation of claim 1, wherein the control unit executes an adaptive acoustic echo cancellation program and the adaptive acoustic echo cancellation program generates the control signals in light of the audio signal and the noise signal detected by the microphones and the audio signal from a remote answer outputted by the speakers, and wherein the speakers of the pillow pad are controlled by the mobile device with the control signals to output the other audio signal and the anti-noise signal that cancels the noise signal resulting from echo in communication.

10. A method of snore and noise cancellation, comprising:
starting a pillow pad and a control unit in a mobile device;
coupling a first communication unit in the pillow pad with a second communication unit in the mobile device;
at least detecting an audio signal or a noise signal by a plurality of microphones in the pillow pad;
generating a plurality of control signals by the control unit in the mobile device according to the audio signal or the noise signal detected by the microphones; and
at least outputting the audio signal or an anti-noise signal by a plurality of speakers that are controlled by the mobile device with the control signals.

11. The method of snore and noise cancellation of claim 10, wherein the pillow pad is made of soft material and foldable along with a folding line to compact volume.

12. The method of snore and noise cancellation of claim 10, wherein the first communication unit and the second communication unit are one of a wired communication module and a wireless communication module.

13. The method of snore and noise cancellation of claim 12, wherein the wireless communication module is a Bluetooth module.

14. The method of snore and noise cancellation of claim 10, wherein the mobile device is a smart phone or a tablet computer.
